(19) United States
(12) Patent Application Publication
(10) Pub. No.: US 2006/0174994 A1
(43) Pub. Date: Aug. 10, 2006

(54) Closed-loop control of power used in ultrasonic consolidation

(76) Inventor: Dawn White, Ann Arbor, MI (US)

Correspondence Address: John G. Posa;Gifford, Krass, Groh, Spinkle,, Anderson & Citkowski, P.C., PO Box 7021, Troy, MI, 48007-7021, US

(21) Appl. No.: 11/274,974

(22) Filed: Nov. 16, 2005

Related U.S. Application Data
(60) Provisional application No. 60/629,283, filed on Nov. 18, 2004.
(60) Provisional application No. 60/671,659, filed on Apr. 15, 2005.

(51) Int. Cl. B32B 37/00; B29C 65/00

(52) U.S. Cl. 156/73.1; 156/73.4; 156/73.2

(57) ABSTRACT

Disclosed is method of enhancing bond quality in an ultrasonic consolidation process using a sonotrode having a power output level. The preferred embodiment includes the steps of inputting a plurality of process parameters associated with a localized geometry over which the ultrasonic consolidation is occurring, and varying the relationship between these parameters to control the power output level to optimize bond quality between layers of material as they are consolidated. The process parameters, alone or in combination, may include the speed of the consolidation; the amplitude of the ultrasonic energy; applied force; and/or temperature.

### REFERENCE TO RELATED APPLICATION

This application claims priority to U.S. Provisional Patent Application Ser. No. 60/629,283, filed Nov. 18, 2004, the entire content of which is incorporated herein by reference.

### FIELD OF THE INVENTION

This invention relates generally to ultrasonic object consolidation and, in particular, to closed-loop control of energy delivered in such systems to optimize process parameters and enhance uniformity.

### BACKGROUND OF THE INVENTION

Ultrasonic consolidation is an additive manufacturing technology used to produce objects of any geometry from uniform, featureless feedstocks, such as tapes, sheets, wires, or droplets. There are a range of methods for accomplishing the metallurgical consolidation of the feedstocks via ultrasonic energy. These include, but are not limited to, spot consolidation, continuous rotary consolidation, plate-type consolidation, and so forth.

My U.S. Pat. No. 6,519,500, the teachings of which are incorporated herein by reference, is directed to a system and a method of fabricating an object by adding material layers incrementally and consolidating the layers through the use of ultrasonic vibrations and pressure. The layers are placed in position to shape the object by a material feeding unit. The raw material may be provided in various forms, including flat sheets, segments of tape, strands of filament or single dots cut from a wire roll. The material may be metallic or plastic, and its composition may vary discontinuously or gradually from one layer to the next, creating a region of functionally gradient material. Plastic or metal matrix composite material feedstocks incorporating reinforcement materials of various compositions and geometries may also be used.

If excess material is applied due to the feedstock geometry employed, such material may be removed after each layer is bonded, or at the end of the process; that is after sufficient material has been consolidated to realize the final object. A variety of tools may be used for material removal, depending on composition and the target application, including knives, drilling or milling machines, laser cutting beams, or ultrasonic cutting tools.

The consolidation is effected by ultrasonic welding equipment, which includes an ultrasonic generator, a transducer, a booster and a head unit, also called a horn or sonotrode. Ultrasonic vibrations are transmitted through the sonotrode to the common contact surface between two or more adjacent layers, which may include layers next to each other on the same plane, and/or layers stacked on top of each other. The orientation of the sonotrode is preferably adjusted so that the direction of the ultrasonic vibrations is normal to the contact surface when consolidating layers of plastic material, and parallel to the contact surface when consolidating layers of metal.

The layers are fed sequentially and additively according to a layer-by-layer computer model description of the object, which is generated by a computer-aided design (CAD) system. The CAD system, which holds the layered description of the object, interfaces with a numerical controller, which in turn controls one or more actuators. The actuators impart motion in multiple directions, preferably three orthogonal directions, so that each layer of material is accurately placed in position and clamped under pressure. The actuators also guide the motion of the sonotrode, so that ultrasonic vibrations are transmitted in the direction required through the common contact surfaces of the layers undergoing consolidation.

During the ultrasonic consolidation process, an ultrasonic power supply is used to drive the sonotrode to a particular amplitude when applying material to a structure. The amount of power required to accomplish this is constantly varying due to the constantly changing geometry of the structure. This is prevalent in free-form fabrication applications, in which an arbitrary geometry is supplied to a manufacturing system, which them produces that arbitrary article from an essentially featureless feedstock, such as tape, wire or other tiny volumes of material.

### SUMMARY OF THE INVENTION

This invention resides in a method of enhancing bond quality in an ultrasonic consolidation process using a sonotrode having a power output level. The preferred embodiment includes the steps of inputting a plurality of process parameters associated with a localized geometry over which the ultrasonic consolidation is occurring, and varying the relationship between these parameters to control the power output level to optimize bond quality between layers of material as they are consolidated. The process parameters, alone or in combination, may include the speed of the consolidation; the amplitude of the ultrasonic energy; applied force; and/or temperature.

### BRIEF DESCRIPTION OF THE DRAWINGS

FIG. 1 is a schematic diagram of an automated ultrasonic consolidation system to which the invention is applicable;

FIG. 2 illustrates the use of support materials to fabricate an object with overhanging parts;

FIG. 3a shows a stacking pattern for tape lay-up;

FIG. 3b shows a basic feed arrangement for tape stock;

FIG. 3c is a drawing of a horizontal section of the object showing adjacent tape segments; and

FIG. 3d is a drawing of a vertical section of the object showing the vertically stacked sections.

### DETAILED DESCRIPTION OF THE INVENTION

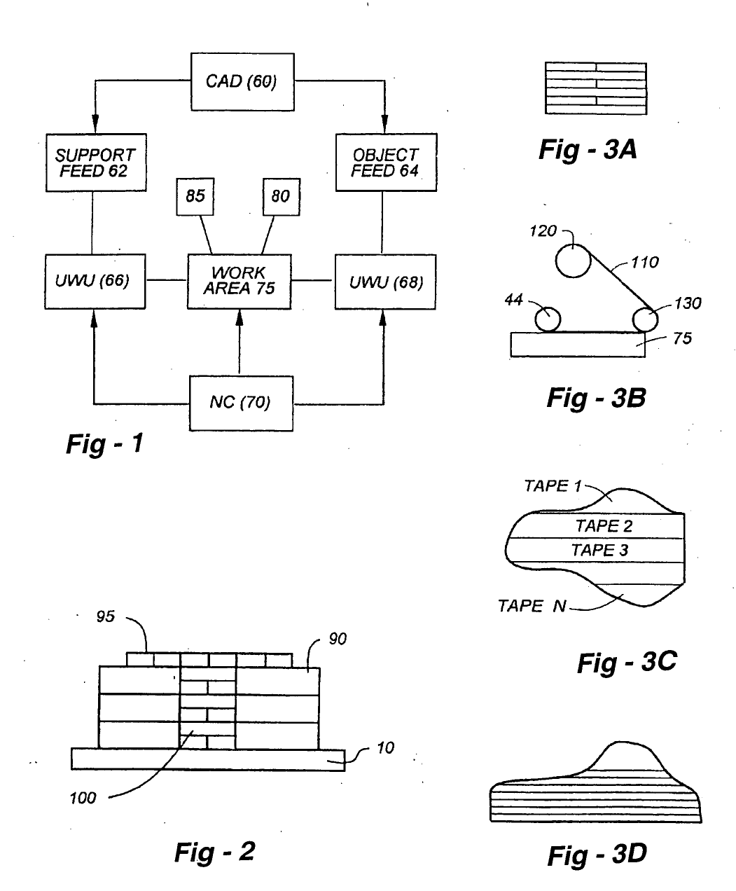

FIG. 1 is a schematic diagram of an automated ultrasonic consolidation system to which the invention is applicable. A computer-aided design unit 60 provides a layer-by-layer description of the object and of the support, as needed. The object material is fed onto the work area 75 by an object-material feed unit 64. The support material is fed onto the work area 75 by a support-material feed unit 62. The feed units may be combined into one when the shapes of the object and support layers are compatible, for instance sheets of plastic are used for the support and sheets of aluminum foil for the object. In general, two different feed units are required.

As shown in FIG. 2, the object may be fabricated by consolidating segments of tape 100 or filament or dots of material, as described below in other embodiments of the invention, while the support for overhanging parts 95 of the object may be constructed by adding layers of support material 90.

The object layers may be either precut, or excess object may be removed by an object removing unit 80, which could be a mechanical or ultrasonic knife, drill, or milling tool, or a laser beam. If used, support material may be removed by a removing unit 85. Sporadic ultrasonic spot-welding of the support material may be limited to the extent necessary to provide a rigid substrate for overhanging parts of the object, thereby facilitating rapid removal of the support by cutting through thin, unwelded sections of the support structure.

The CAD system 60 interfaces with a numerical controller 70, which controls an actuation system (not shown). The actuation system brings the support feed unit 62, the support ultrasonic welding unit 66, the object feed unit 64 and the object ultrasonic welding unit 68 into proper position in the work area 75, so that the ultrasonic consolidation of the layers takes place according to the CAD description of the object and support. The actuation system also controls the vertical motion of the substrate or anvil and the motion of any additional vertical clamps required by the application, so that clamping pressure may be applied on two layers undergoing consolidation.

Feedstock in the form of sheets is often difficult to handle and maintain under uniform in-plane tension and pressure orthogonal to its plane; it may require very wide rollers to be fitted to the sonotrode, and successive passes of the roller to cover the entire sheet. A preferred approach with respect to wide objects is to build such an object from layers of material which are cut from a roll of tape. FIGS. 3a through 3d illustrate the building of an object by tape lay-up. FIG. 3a shows a typical lamination stacking pattern, in which the layers of tape forming one section of the object have a direction which is at a 90 degree angle with the direction of the layers of tape forming the next section of the object.

The set-up of the operation is shown in FIG. 3b. A feed spool 120 holds the tape 110, which passes through a tension roll 130 and is fed on to the work area 75 to be consolidated with previous layers by the roller 44 of a sonotrode. The tape is usually 1 to 2 inches wide. FIG. 3c is a drawing of a horizontal section of the object showing adjacent tape segments, and FIG. 3d is a drawing of a vertical section of the object showing the vertically stacked sections.

For this process, ultrasonic vibrations are preferably transmitted in two orthogonal directions, namely, between the horizontal sections, and between the vertical surfaces of adjacent segments of tape forming each section. Such a configuration permits full consolidation, so that the bond lines which are visible in the stacking pattern of FIG. 7a, are no longer visible after consolidation.

In accordance with the present invention, it has been observed that for any given, constantly changing geometry, the instantaneous geometry over which the ultrasonic consolidation is occurring can be correlated with a minimum power level required to drive the power supply which must be attained in order to produce an ultrasonically consolidated volume in that location. A number of process factors affect the power supply behavior, such as speed, amplitude, force, and even the temperature of the interface. By slightly varying the relationship between these parameters, variations in power outputs can be controlled to ensure that the optimum bond quality is achieved between layers of material as they are applied.

Various control schemes may be suitable for achieving such control over the power supplying including but not limited to fuzzy logic, expert, and other rule-based systems, neural-network-based systems, genetic algorithms, and other advanced artificial intelligence methods understood to skilled controls engineers.

Advanced model-based adaptive controllers such as Kalman filters, pole-placement systems, etc. may also be suitable in these applications, as may hierarchical systems employing more than one of these systems. Further, secondary sensor inputs such as acoustic input, thermal measurements, real-time vibrometry measurements on a part as it is being produced may be usefully employed with power supply output, independently, or together as a means of developing more complete data suitable for driving the power supply, mediating among various control strategies.

I claim:

1. A method of enhancing bond quality in an ultrasonic consolidation process using a sonotrode having a power output level, comprising the steps of:
inputting a plurality of process parameters associated with a localized geometry over which the ultrasonic consolidation is occurring; and
varying the relationship between these parameters to control the power output level to optimize bond quality between layers of material as they are consolidated.

2. The method of claim 1, wherein the process parameter is the speed of the consolidation.

3. The method of claim 1, wherein the process parameter is the amplitude of the ultrasonic energy.

4. The method of claim 1, wherein the process parameter is applied force.

5. The method of claim 1, wherein the process parameter is temperature.
